(19) United States
(12) Patent Application Publication
(10) Pub. No.: US 2003/0062152 A1
(43) Pub. Date: Apr. 3, 2003

(54) Radiator for supercritical vapor compression type refrigerating cycle

(76) Inventors: Yasutaka Kuroda, Anjo-city (JP); Yoshitaka Tomatsu, Chiryu-city (JP); Nobuharu Kakehashi, Toyoake-city (JP); Motohiro Yamaguchi, Hoi-gun (JP)

Correspondence Address: HARNESS, DICKEY & PIERCE, P.L.C., P.O. BOX 828, BLOOMFIELD HILLS, MI, 48303, US

(21) Appl. No.: 10/280,961

(22) Filed: Oct. 25, 2002

Related U.S. Application Data
(62) Division of application No. 09/664,076, filed on Sep. 18, 2000, now abandoned.

(30) Foreign Application Priority Data
Sep. 29, 1999 (JP) 11-276934

(51) Int. Cl. F28F 1/00; F25B 1/00; B60H 1/00; B60H 1/32

(52) U.S. Cl. 165/202; 165/41; 62/244; 62/114

(57) ABSTRACT

In a radiator for a supercritical cycle, a refrigerant outlet is provided at a position higher than that of a refrigerant inlet in a vertical direction such that refrigerant flows from a lower side to an upper side in the radiator. Accordingly, even when temperature of cool air to pass through the lower side of the radiator is high, the temperature of refrigerant flowing in the lower side is so high that a sufficient difference in temperature between cool air and refrigerant can be provided. As a result, a cooling efficiency of refrigerant can be improved.

### CROSS REFERENCE TO RELATED APPLICATION

This application is based upon and claims the benefit of Japanese Patent Application No. 11-276934 filed on Sep. 29, 1999, the contents of which are incorporated herein by reference.

### BACKGROUND OF THE INVENTION

1. Field of the Invention

This invention relates to a radiator (gas cooler) applied to a supercritical vapor compression type refrigerating cycle (hereinafter, referred to as a supercritical cycle) in which refrigerant pressure at a high-pressure side (discharge side) becomes a supercritical pressure of refrigerant or more.

2. Description of the Related Art

In a supercritical cycle using fleon as refrigerant, since a pressure at a high-pressure side is smaller than a supercritical pressure of refrigerant, refrigerant changes its phase (condenses) in a condenser from a gaseous phase to a liquid phase while keeping its temperature approximately constant. A refrigerant density is increased in the condenser as it proceeds from a refrigerant inlet to a refrigerant outlet. Therefore, the position of the refrigerant inlet is generally higher than that of the refrigerant outlet. Meanwhile, a vehicle air conditioner is generally installed in a vehicle front part such that a cooling heat exchanger such as a condenser or a radiator can take cool air in easily.

### SUMMARY OF THE INVENTION

In this connection, a temperature of cool air to pass through the cooling heat exchanger was measured to improve a cooling capability of the air conditioner when the vehicle was stopped. Accordingly, it was found that the temperature of cool air to pass through the lower side of the heat exchanger was higher than that of cool air to pass through the upper side of the heat exchanger.

That is, when the vehicle is stopped, as shown in FIG. 10, cool air to flow into the lower side of the heat exchanger 200 is heated by heat (ground heat), radiated from the ground, and hot air, discharged from an engine room, to have a temperature higher than that of cool air to flow into the upper side of the heat exchanger. Incidentally, it was experimentally confirmed that cool air of about 55° C. flew into the lower side while cool air of about 45° C. flew into the upper side when an outside air temperature was 40° C. As understood from this example, there arises a large difference in temperature of cool air between the lower side and the upper side of the heat exchanger for cooling.

The present invention has been made in view of the above problems. An object of the present invention is to improve a cooling efficiency of refrigerant in a radiator for a supercritical cycle.

According to a first aspect of the present invention, a refrigerant outlet is elevated from a refrigerant inlet in a vertical direction in a radiator. Accordingly, refrigerant flows into a lower side of the radiator with a temperature higher than that in an upper side of the radiator. Therefore, even when a temperature of cool air at the lower side is higher than that at the upper side, a sufficient difference in temperature between refrigerant and cool air can be provided, resulting in improvement of refrigerant cooling efficiency.

According to a second aspect of the present invention, a radiator includes a plurality of tubes each extending in a horizontal direction and defining therein a refrigerant passage in which refrigerant flows. In the plurality of tubes, a first one of the tubes, which is provided at a position higher than that of a second one of the tubes, has a cross-sectional area of the refrigerant passage larger than that of the second one of the tubes. Each of the plurality of tubes may have a plurality of refrigerant passages.

When each of the plurality of tubes has a plurality of refrigerant passages, a number of the plurality of refrigerant passages of a first one of the tubes, which is provided at a position higher than a second one of the tubes, can be larger than that of the second one of the tubes.

Accordingly, a large amount of refrigerant can flow in the upper portion of the radiator, through which cool air passes with a lower temperature, as compared to that of refrigerant flowing in the lower portion of the radiator. This also results in improved cooling efficiency. In these cases, it is preferable that a refrigerant inlet is elevated from a refrigerant outlet in the vertical direction.

### BRIEF DESCRIPTION OF THE DRAWINGS

Other objects and features of the present invention will become more readily apparent from a better understanding of the preferred embodiments described below with reference to the following drawings, in which;

FIG. 1 is a schematic diagram showing a vehicle installing therein a radiator according to a first preferred embodiment;

FIG. 2 is a front view schematically showing the radiator installed in the vehicle in the first embodiment;

FIG. 3 is a cross-sectional view showing a tube of the radiator;

FIG. 4 is a p-h diagram of carbon dioxide;

FIG. 5 is a front view schematically showing a modified radiator according to the first embodiment;

FIG. 6 is a front view schematically showing a radiator according to a second preferred embodiment;

FIG. 7 is a front view schematically showing a radiator according to a third preferred embodiment;

FIG. 8 is a front view schematically showing a modified radiator according to the third embodiment;

FIG. 9 is a front view schematically showing a radiator according to a fourth preferred embodiment; and

FIG. 10 is an explanatory diagram for explaining problems to be solved by the present invention.

### DETAILED DESCRIPTION OF THE PREFERRED EMBODIMENTS

Hereinafter, preferred embodiments are explained with reference to appended drawings through which the same parts and components are denoted with the same reference numerals.

(First Embodiment)

In a first preferred embodiment, a radiator for a supercritical cycle according to the present invention is applied to a vehicle air conditioner.

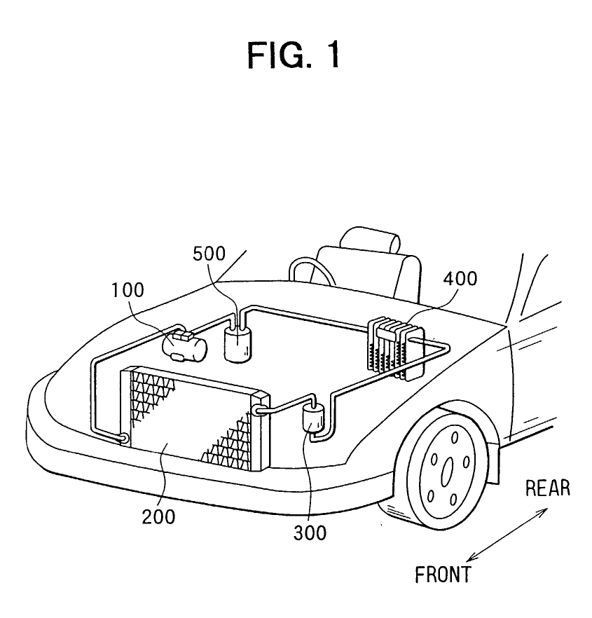

Referring to FIG. 1 showing the supercritical cycle (vehicle air conditioner) installed in a vehicle, a compressor 100 sucks refrigerant (carbon dioxide in the present embodiment) and compresses it while receiving a drive power from a vehicle engine (not shown). High-pressure refrigerant discharged from the compressor 100 flows into a radiator 200 to exchange heat with air (cool air) to be cooled down. The radiator 200 is explained in detail later.

A pressure-control valve 300 decompresses refrigerant discharged from the radiator 200 while controlling a temperature of the refrigerant at the outlet side of the radiator 200 so that a coefficient of performance (COP) of the supercritical cycle is maximum. The pressure-control valve 300 has substantially the same functions as disclosed in JP-A-9-264622, and therefore is not explained in detail here.

An evaporator 400 evaporates refrigerant, decompressed by the pressure-controlled valve 300, to exhibit a refrigerating capability (cooling capability). Refrigerant flowing out of the evaporator 400 flows into an accumulator (gas-liquid separator) 500. The accumulator 500 separates the refrigerant into gaseous phase refrigerant and liquid phase refrigerant and send gaseous phase refrigerant toward the suction side of the compressor 100 while accumulating therein surplus refrigerant for the supercritical cycle.

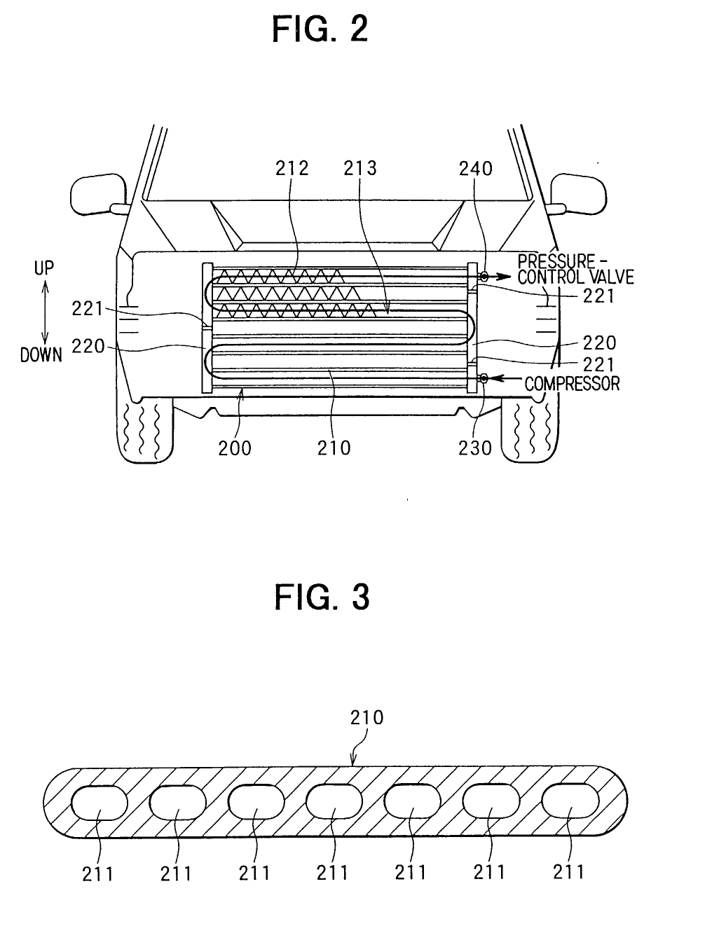

Next, the radiator 200 according to the present embodiment is explained with reference to FIG. 2. The radiator 200 has plural tubes 210 in which refrigerant flows. The tubes 210 are arranged in parallel in a vertical direction and respectively extend in a horizontal direction. As shown in FIG. 3, each of the tubes 210 is formed by extruding or drawing to have plural refrigerant passages 211 therein. A corrugated fin 212 is provided between adjacent two of the tubes 210, thereby constituting a heat exchange core 213 for cooling refrigerant.

Header tanks 220 are disposed at both ends in a longitudinal direction of the tubes 210, and communicate with the tubes 210. Each inside space of the header tanks 220 is divided into several spaces by partition plates (separators) 221. A refrigerant inlet 230 is provided at the lower side of one of the header tanks 220, i.e., at the lower side of the radiator 200, to receive refrigerant discharged from the compressor 100. On the other hand, a refrigerant outlet 240 is provided at the upper side of the one of the header tanks 220, i.e., at the upper side of the radiator 200, to discharge refrigerant that has been heat-exchanged in the radiator 200. Accordingly, refrigerant flows in the radiator 200 from the lower side to the upper side while meandering in the radiator 200 as indicated by an arrow in FIG. 2.

Next, features of the present embodiment are described below According to the present embodiment, the refrigerant inlet 230 is provided at the lower side of the header tank 220 (radiator 200), while the refrigerant outlet 240 is provided at the upper side of the header tank 220 (radiator 200). That is, when the radiator 200 is installed in the vehicle, the refrigerant outlet 240 is elevated from the refrigerant inlet 230 in a vertical direction in the radiator 200.

Further, in the supercritical cycle, high-pressure side refrigerant flows in the radiator 200 from the refrigerant inlet 230 toward the refrigerant outlet 240 while lowering its temperature. Therefore, the temperature of refrigerant at the refrigerant inlet 230 is higher than that at the refrigerant outlet 240. On the other hand, the temperature of cool air is, as described above, high at the lower side of the radiator 200 as compared to that at the upper side. However, in the present embodiment, even when the temperature of cool air is high at the lower side, the temperature of refrigerant conducted into the radiator 200 from the lower side has so high that a sufficient difference in temperature between refrigerant and cool air can be provided at the lower side. As a result, the cooling efficiency of refrigerant can be improved in the radiator 200 of the supercritical cycle, resulting in improved cooling capability (refrigerating capability) of the air conditioner (supercritical cycle).

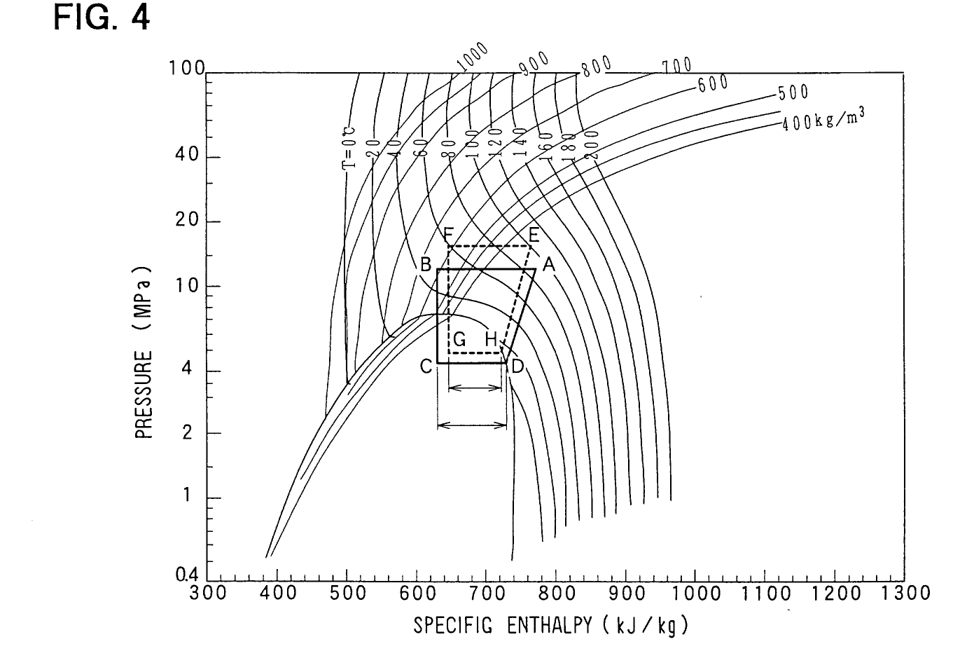

Incidentally, FIG. 4 is a Mollier diagram in which solid lines A-B-C-D indicate the operation of the supercritical cycle according to the present embodiment, and broken lines E-F-G-H indicate an operation of a supercritical cycle in which refrigerant is made to flow from an upper side to a lower side in a radiator. As understood from the diagram, according to the present embodiment, the refrigerating capability (a difference in enthalpy between C and D) is increased at about 18% as compared to the conventional refrigerating capability (a difference in enthalpy between G and H).

The present embodiment is not limited to the radiator 200 shown in FIG. 2, but may be applied to the radiator 200 shown in FIG. 5 in which the number of the partition plates (separators) 221 is decreased as compared to that in FIG. 2 such that a turn number of refrigerant in the radiator 200 is decreased. The number of the partition plates 221 can also be increased as compared to that shown in FIG. 2 to increase the turn number of refrigerant in the radiator 200.

(Second Embodiment)

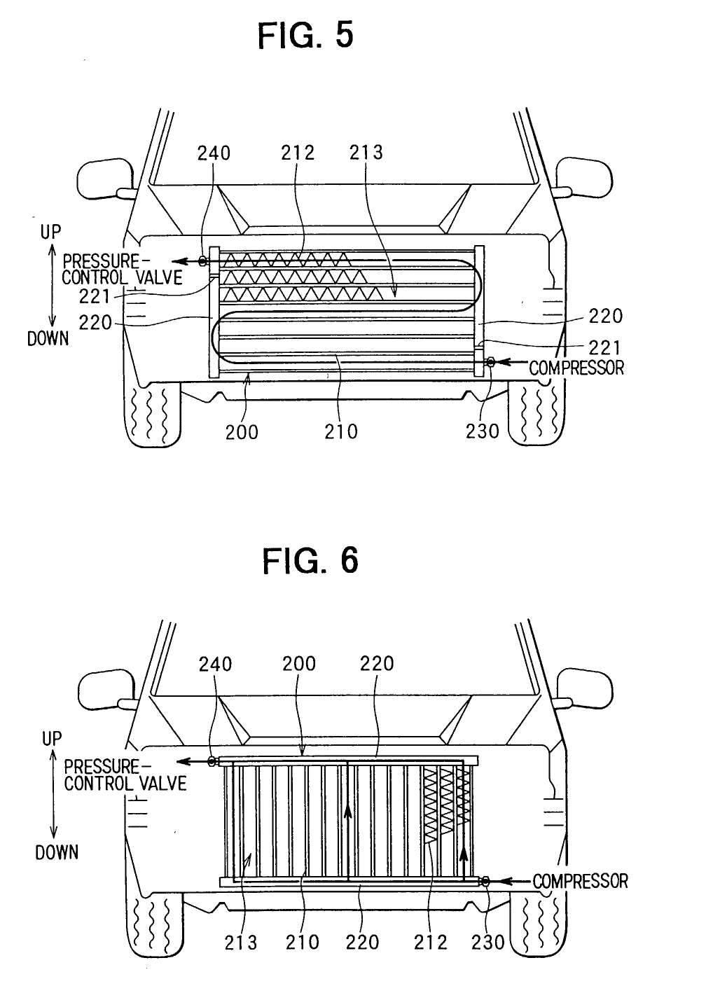

In the first embodiment, the tubes 210 are provided to extend in the horizontal direction. However, in a second preferred embodiment, as shown in FIG. 6, the tubes 210 may be arranged such that those longitudinal direction corresponds to a vertical direction and such that refrigerant flows therein from the lower side to the upper side.

(Third Embodiment)

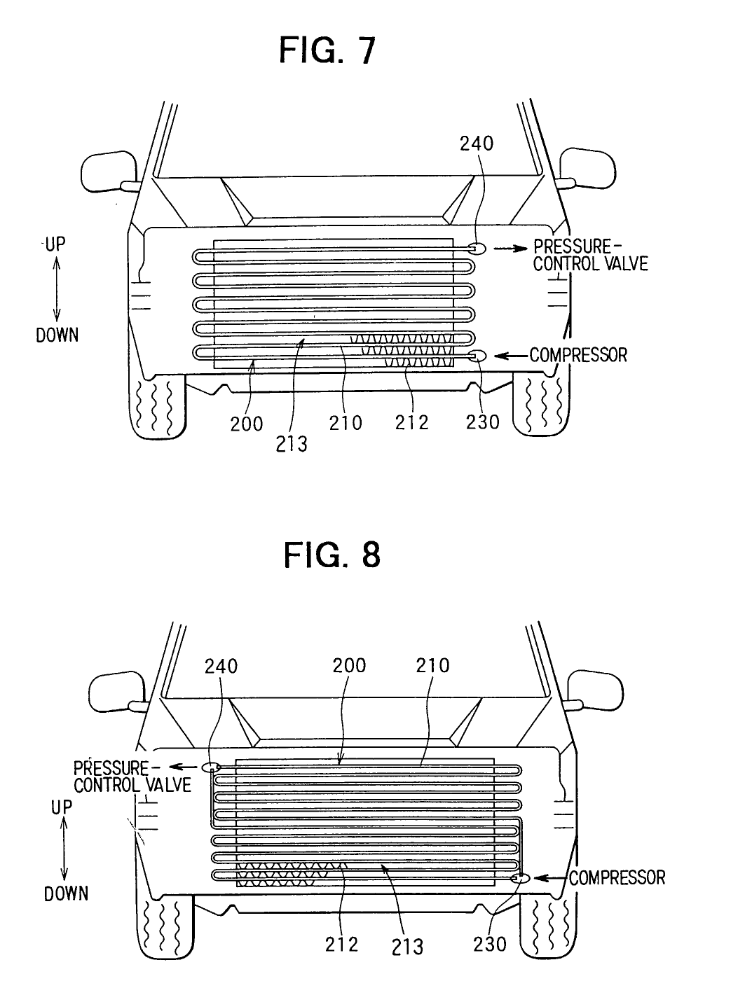

In a third preferred embodiment, as shown in FIGS. 7 and 8, the tubes 210 meander and dispense with the header tanks 220 to constitute the heat exchange core 213. In FIG. 7, only one tube 210 is made to meander from the refrigerant inlet 230 to the refrigerant outlet 240. In FIG. 8, several (two in the figure) tubes 210 are made to meander from the refrigerant inlet 230 to the refrigerant outlet 240.

(Fourth Embodiment)

In the first embodiment, refrigerant flows from the lower side to the upper side in the radiator 200 against gravity. This may deteriorate a flowing performance of refrigerant and a dividing performance for dividing refrigerant into the respective tubes 210 from the header tanks 220.

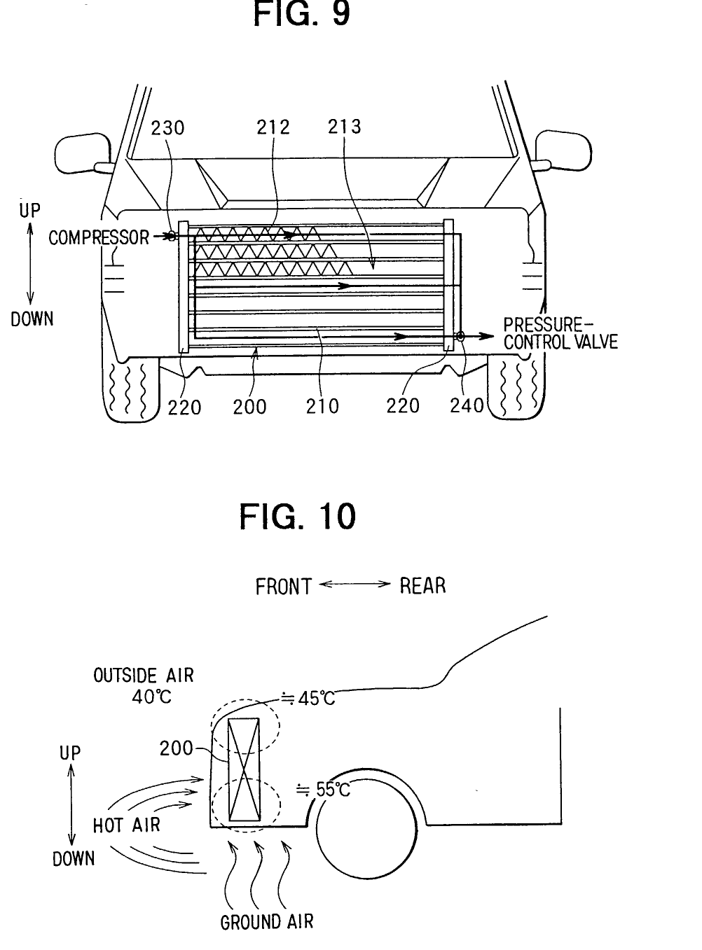

In this connection, in a fourth preferred embodiment, as shown in FIG. 9, the refrigerant inlet 230 is provided at the upper side of the radiator 200 (one of the header tanks 220), and the refrigerant outlet 240 is provided at the lower side of the radiator 200 (the other one of the header tanks 220). Further, some of the tubes 210 arranged at the upper side respectively have a passage cross-sectional area (diameter of each refrigerant passage 211) larger than that of the other tubes 210 arranged at the lower side.

Accordingly, refrigerant flows from the upper side to the lower side. Simultaneously, the upper side of the radiator 200, through which cool air flows with a lower temperature, allows a large amount of refrigerant to flow therein as compared to the lower side, thereby providing a large difference in temperature between conditioning air and refrigerant. As a result, the radiator 200 in the supercritical cycle can improve the cooling efficiency and the dividing performance of refrigerant simultaneously.

In the present embodiment, the passage cross-sectional area of the tube positioned at the upper side is larger than that of the tube positioned at the lower side. However, the number of the refrigerant passages 211 in the tube positioned at the upper side may be increased as compared to that at the lower side. In such case, the same effects can be provided.

While the present invention has been shown and described with reference to the foregoing preferred embodiments, it will be apparent to those skilled in the art that changes in form and detail may be made therein without departing from the scope of the invention as defined in the appended claims.

For instance, although carbon dioxide is used as refrigerant in the supercritical cycle in the above embodiments, the present invention can be applied to other supercritical cycles using refrigerant other than carbon dioxide, such as ethylene, ethane, and nitrogen oxide.

What is claimed is:

1. A radiator for cooling refrigerant discharged from a compressor with a high pressure in a supercritical refrigerating cycle in which a pressure at a high-pressure side is a supercritical pressure of the refrigerant at least, the radiator comprising:
a heat exchange core portion defining therein a refrigerant passage in which refrigerant flows to be cooled, the heat exchange core portion having a refrigerant inlet for conducting the refrigerant into the refrigerant passage and a refrigerant outlet for discharging the refrigerant from the refrigerant passage;
wherein the refrigerant outlet is elevated from the refrigerant inlet in a vertical direction.

2. A radiator for cooling refrigerant discharged from a compressor with a high pressure in a supercritical refrigerating cycle in which a pressure at a high-pressure side is a supercritical pressure of the refrigerant at least, the radiator comprising:
a heat exchange core portion defining a refrigerant passage in which refrigerant flows to be cooled, the heat exchange core portion being constructed such that refrigerant flowing in an upper portion of the heat exchange core portion has a temperature lower than that of refrigerant flowing in a lower portion of the heat exchange core portion.

3. A radiator for cooling refrigerant discharged from a compressor with a high pressure in a supercritical refrigerating cycle in which a pressure at a high-pressure side is a supercritical pressure of the refrigerant at least, the radiator comprising:
a plurality of tubes extending in a horizontal direction in parallel with one another and each defining therein a refrigerant passage in which refrigerant flows; and
first and second header tanks respectively provided at both ends in a longitudinal direction of the plurality of tubes to communicate with the plurality of tubes,
wherein a first one of the plurality of tubes, a position of which is higher than that of a second one of the plurality of tubes, has a cross-sectional area of the refrigerant passage larger than that of the second one of the plurality of tubes.

4. The radiator of claim 3, wherein
the first one of the plurality of tubes is provided at an upper side of the plurality of tubes in a vertical direction; and
the second one of the plurality of tubes is provided at a lower side of the plurality of tubes in the vertical direction.

5. The radiator of claim 3, wherein:
the plurality of tubes has a first group of tubes positioned at an upper side of a center line thereof in a vertical direction, and a second group of tubes positioned at a lower side of the center line;
the first group of tubes includes the first one of the plurality of tubes; and
the second group of tubes includes the second one of the plurality of tubes.

6. The radiator of claim 3, wherein:
the first and second header thanks have a refrigerant inlet through which the refrigerant is conducted into the plurality of tubes and a refrigerant outlet from which the refrigerant is discharged from the plurality of tubes, the refrigerant inlet being elevated from the refrigerant outlet in a vertical direction.

7. A radiator for cooling refrigerant discharged from a compressor with a high pressure in a supercritical refrigerating cycle in which a pressure at a high-pressure side is a supercritical pressure of the refrigerant at least, the radiator comprising:
a plurality of tubes extending in a horizontal direction in parallel with one another and each defining therein a plurality of refrigerant passages in which refrigerant flows; and
first and second header tanks respectively provided at both ends in a longitudinal direction of the plurality of tubes to communicate with the plurality of tubes,
wherein a number of the plurality of refrigerant passages of a first one of the plurality of tubes, a position of which is higher than that of a second one of the plurality of tubes, is larger than that of the second one of the plurality of tubes.

8. The radiator of claim 7, wherein
the first one of the plurality of tubes is provided at an upper side of the plurality of tubes in a vertical direction; and
the second one of the plurality of tubes is provided at a lower side of the plurality of tubes in the vertical direction.

9. The radiator of claim 7, wherein:
the plurality of tubes has a first group of tubes positioned at an upper side of a center line thereof in a vertical direction, and a second group of tubes positioned at a lower side of the center line;
the first group of tubes include the first one of the plurality of tubes; and
the second group of tubes includes the second one of the plurality of tubes.

10. The radiator of claim 7, wherein:
the first and second header thanks have a refrigerant inlet through which the refrigerant is introduced into the plurality of tubes and a refrigerant outlet through which the refrigerant is discharged from the plurality of tubes, the refrigerant inlet being elevated from the refrigerant outlet in a vertical direction.

11. An on-vehicle structure of a radiator installed in a vehicle for cooling refrigerant discharged from a compressor with a high pressure equal to or larger than a supercritical pressure of the refrigerant in a supercritical cycle, the structure comprising:
a heat exchange core portion defining therein a refrigerant passage in which refrigerant flows to be cooled, the heat exchange core portion having a refrigerant inlet through which the refrigerant is conducted, and a refrigerant outlet through which the refrigerant is discharged, the refrigerant outlet being elevated from the refrigerant inlet in a vertical direction.
